(19) United States
(12) Patent Application Publication
(10) Pub. No.: US 2005/0229286 A1
(43) Pub. Date: Oct. 20, 2005

(54) Golf glove and replaceable saving pads

(76) Inventors: Yung-lung Tseng, Laguna Hills, CA (US); Min-ying C. Tseng, Laguna Hills, CA (US); Conray C. Tseng, Laguna Hills, CA (US)

Correspondence Address: Yung-lung Tseng, 27236 Westridge Lane, Laguna Hills, CA, 92653, US

(21) Appl. No.: 10/827,208

(22) Filed: Apr. 20, 2004

(51) Int. Cl. A41D 13/00; A47J 45/10

(52) U.S. Cl. 2/161.2

(57) ABSTRACT

Golf glove saving pads can be used and attached to a golf glove to serve as a glove saver. The saving pads comprise at least one layer of non-slip material that has a double sided glue tape, or a layer of releasable glue in stead, at the bottom so that the golf glove saving pads can be attached onto a golf glove and secured during golf swings. The whole golf glove saving pads can be easily removed by using the hot air to soften the glue bonding to a golf glove, therefore they are replaceable. Moreover, the golf glove saving pads also serve as a moisture barrier to eliminate the effect due to the moisture from the perspiration of the hands that causes the golf glove to become weaker to sustain the stress during golf swings, therefore, the golf glove saving pad can extend the normal usage life of a golf glove.

### REFERENCES CITED

U.S. Pat. No. 3,532,344 October, 1970 Masstab.
U.S. Pat. No. 3,863,271 February, 1975 Moroney
U.S. Pat. No. 4,329,741 May, 1982 Bach
U.S. Pat. No. 5,253,367 October, 1993 Lappley
U.S. Pat. No. 5,423,089 June, 1995 Chun et al.
U.S. Pat. No. 5,634,214 June, 1997 St. Ville
U.S. Pat. No. 5,855,022 January, 1999 Storto
U.S. Pat. No. 6,052,827 April, 2000 Widdemer
U.S. Pat. No. 6,154,885 December, 2000 Kobayashi et al.
U.S. Pat. No. 6,546,599 B2 April, 2003 Pelt et al.
U.S. Pat. No. 6,708,346 B2 March, 2004 Terris et al.

### BACKGROUND OF THE INVENTION

The present invention relates to the golf glove with replaceable saving pads. The game of golf has been known as a strenuous exercise which uses only certain portions of the hand from both hands to control the accuracy of a swing. During a golf game, a glove is generally used for the player to protect sensitive skin on the hand. Golf gloves normally are made of soft leather which provides golfers with more comfortable feeling than the other materials, when golfers perform golf swings. Since the golf game is a strenuous exercise, the golf glove wears out very quickly due to the nature of soft leather. To worsen the problem, the moisture from the perspiration of the hands causes the golf glove to become even weaker to sustain the stress during golf swings. Two weakest areas of a golf glove are at the palm and the thumb locations. The other areas seem to remain at quite good conditions when the palm and the thumb areas are worn out and the glove becomes not usable practically. To many golfers, this becomes extra financial cost to enjoy a golf game. To save golf glove has been attempted by using drying method in the past and can be found in prior art patent disclosure shown in Pelt et al. U.S. Pat. No. 6,546,599 B2.

The modifications of a golf glove have been attempted in the past and the improvements are mainly related to grip control. They can be found in prior art patent disclosures shown in U.S. Pat. Nos. Masstab U.S. Pat. No. 3,532,344, Moroney U.S. Pat. No. 3,863,271, Bach U.S. Pat. No. 4,329,741, Lappley U.S. Pat. No. 5,253,367, Chun et al. U.S. Pat. No. 5,423,089, St. Ville U.S. Pat. No. 5,634,214, Storto U.S. Pat. No. 5,855,022, Widdemer U.S. Pat. No. 6,052,827, Kobayashi et al. U.S. Pat. No. 6,154,885, and Terris et al U.S. Pat. No. 6,708,346 B2. Various types of pad were used in the above patent disclosures; they are either different in shape or the material used to fill inside the pad. However, they have one thing in common, i.e., the pad is permanently attached to the golf glove. In other words, the golf glove will loss its integrity if the pad is removed. This is very different from golf glove saving pads of the present invention.

The pads used at the palm and the finger, such as thumb, areas of a golf glove in the present invention can be attached to any golf glove and are removable. They can be easily removed with the aid of hot air without changing any integrity of the golf glove. Therefore, the golf glove saving pads of the present invention are replaceable. Since the pads used in the present invention prevent the grip of golf club from directly contacting the soft leather surfaces of the palm and the thumb areas of a golf glove, those areas are protected and can not be easily worn out by the stress during golf swings. Moreover, the pads used in the present invention also serve as a moisture barrier to eliminate the effect due to the moisture from the perspiration of the hands that causes the golf glove to become even weaker to sustain the stress during golf swings. To replace the pads used in the present invention is much cheaper than to buy a new golf glove, therefore, the present invention is a golf glove saver.

### SUMMARY OF THE INVENTION

It is an object of the present invention to provide a golf glove with saving pads.

It is another object of the present invention to provide golf glove saving pads that can be used and attached to commercially available golf gloves.

It is an additional object of the present invention to provide golf glove saving pads which are replaceable.

It is a further object of the present invention to provide golf glove saving pads to extend the normal usage life of a golf glove.

The saving pad of the present invention for the palm area of a golf glove has an irregular pear shape to fit to the hand when the golfer holds a golf club. While the saving pad of the present invention for the finger, such as thumb, area of a golf glove has an elongated oval shape to fit to the inner side of the thumb. The golf glove saving pad of the present invention comprises multi-layers of material that are bonded together by a double sided glue tape, glue or sewing.

The inner layer of saving pad of the first embodiment of the present invention is made of thin, lightweight, porous, elastic, self-adhering material. The outer layer of saving pad of the first embodiment of the present invention is made of a flexible, non-slip, non-self-adhering material. Due to the elastic nature of the inner layer of this embodiment, the golf glove saving pads of the present invention can provide some cushion function to the golfer.

The inner layer of saving pad of the second embodiment of the present invention is made of flexible, non-slip, non-self-adhering material. The outer layer of saving pad of the second embodiment of the present invention is made of thin, lightweight, porous, elastic, self-adhering material which has extra no-slip feature. The golf glove saving pads of the second embodiment of the present invention can provide some grip control function to the golfer.

The inner layer of saving pad of the third embodiment of the present invention is made of thin, lightweight, porous, elastic, self-adhering material. The outer layer of saving pad of the third embodiment of the present invention is made of thin, lightweight, porous, elastic, self-adhering material which has extra non-slip feature. Since both layers are self-adhering materials, they can be bonded together without glue tape, glue, or sewing. The golf glove saving pads of the third embodiment of the present invention can provide both some cushion function and some grip control function to the golfer.

The fourth embodiment of the present invention comprises a golf glove that has a saving pad with an irregular pear shape at the palm area and a saving pad with an elongated oval shape at the thumb area.

A double sided glue tape is attached to the bottom of each golf glove saving pad of the present invention. It may be replaced by a layer of releasable glue. This double sided glue tape allows the golf glove saving pad of the present invention to be used and attached to commercially available golf glove and to serve as a glove saver. The bottom double sided glue tape secures the golf glove saving pads of the present invention on a golf glove during golf swings. The whole golf glove saving pads of the present invention can be easily removed by using the hot air to soften the glue tape bonding to a golf glove, therefore they are replaceable.

Golf gloves normally are made of soft leather which provides golfers with more comfortable feeling than the other materials, when golfers perform golf swings. Since the golf game is a strenuous exercise, the golf glove wears out very quickly due to the nature of soft leather. To worsen the problem, the moisture from the perspiration of the hands causes the golf glove to become even weaker to sustain the stress during golf swings. Since the pads used in the present invention prevent the grip of golf club from directly contacting the soft leather surfaces of the palm and the thumb areas of a golf glove, those areas are protected and can not be easily worn out by the stress during golf swings. Moreover, the pads used in the present invention also serve as a moisture barrier to eliminate the effect due to the moisture from the perspiration of the hands that causes the golf glove to become even weaker to sustain the stress during golf swings. To replace the pads used in the present invention is much cheaper than to buy a new golf glove, therefore, the present invention serves as a golf glove saver.

### BRIEF DESCRIPTION OF THE DRAWINGS

FIG. 1 is a top view of a golf glove with saving pads at palm area and thumb area.

FIG. 2 is a top view of a golf glove saving pad for the palm area of a golf glove.

FIG. 3 is a top view of a golf glove saving pad for the finger, such as thumb, area of a golf glove.

FIG. 4 is a cross-sectional elevation view of the first embodiment of a golf glove saving pad of FIG. 2, taken along line 2-2 of FIG. 2, showing a double sided glue tape between the inner layer and the outer layer, and the bottom double sided glue tape before they are assembled.

FIG. 5 is a cross-sectional elevation view of the second embodiment of a golf glove saving pad of FIG. 2, taken along line 2-2 of FIG. 2, showing a double sided glue tape between the inner layer and the outer layer, and the bottom double sided glue tape before they are assembled.

FIG. 6 is a cross-sectional elevation view of the third embodiment of a golf glove saving pad of FIG. 2, taken along line 2-2 of FIG. 2, showing the inner layer, the outer layer, and a double sided glue tape at the bottom before they are assembled.

FIG. 7 is a top view of the fourth embodiment of the present invention with saving pads at palm area and thumb area.

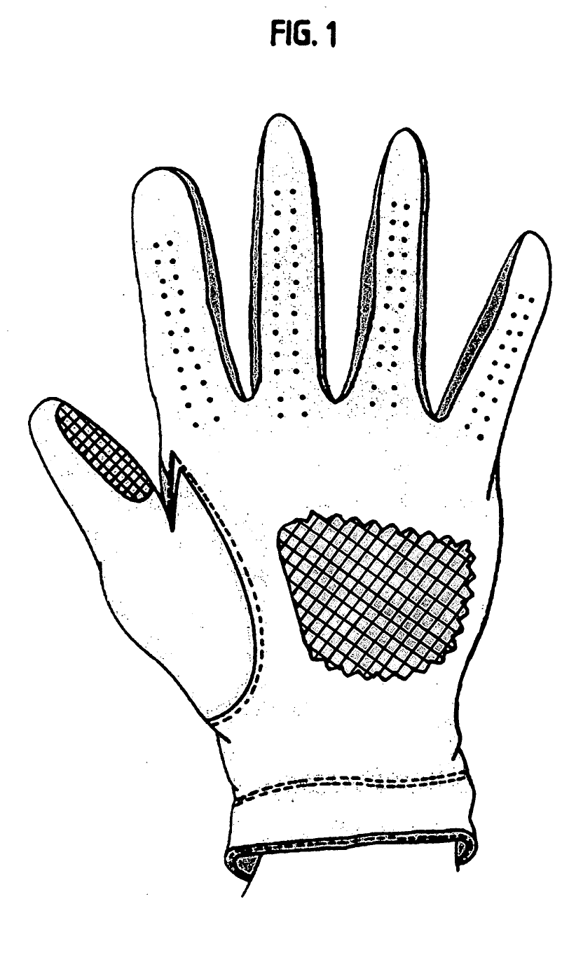

### DETAILED DESCRIPTION OF THE PREFERRED EMBODIMENT

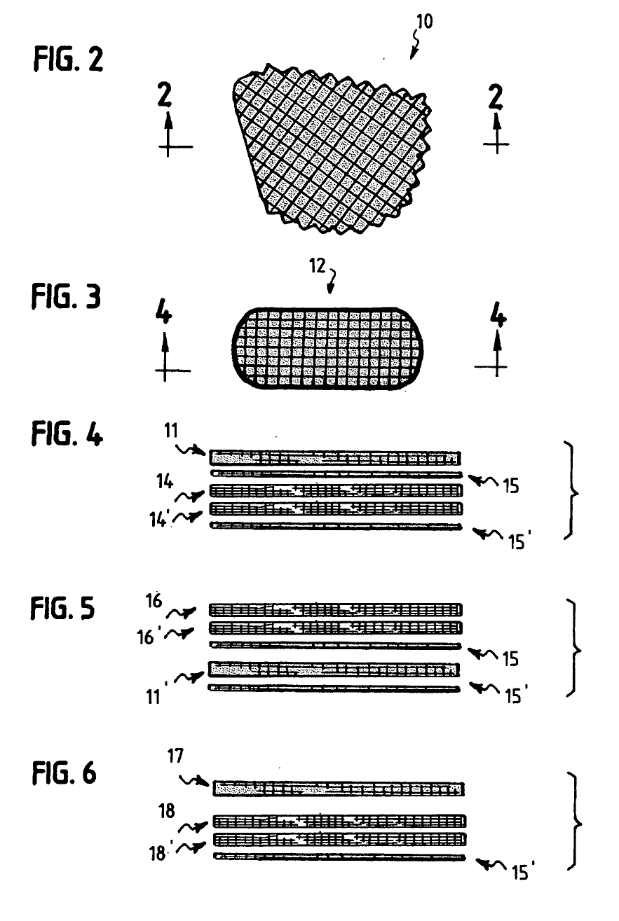

The first embodiment of the present invention, as illustrated in FIG. 4, for golf glove saving pads 10 and 12, as shown in FIGS. 2 and 3, comprises a single outer layer 11 and double inner layers 14 and 14′. They are bonded together by a double sided glue tape 15. The outer layer 11 is made of flexible, non-slip, non-self-adhering material. Examples of this type of material useful in the present invention are fabric, leather (natural or artificial), foam and the like. The double inner layers 14 and 14′ are made of thin, lightweight, porous, elastic material having self-adhering capability. Examples of this type of material useful in the present invention are Coban ®, Coach® and the like. Coban® is available from 3M Co. located in St. Paul, Minn. Coban® comprises a non-woven polyester fiber base material, elastic threads running through the base material in the longitudinal direction and a layer of latex. While Coach® is available from Johnson and Johnson Co. located in Skillman, N.J. Coach® contains natural rubber latex. Example of the double sided glue tape 15 useful in the present invention is carpet tape from Henkel® Consumer Adhesive, Inc. located in Avon, Ohio.

In a first embodiment of the construction, as illustrated in FIG. 4, for the golf glove saving pads 10 and 12 as illustrated in FIGS. 2 and 3, double layers of thin, lightweight, porous, elastic, self-adhering material 14 and 14′, used for the inner layer of golf glove saving pad of the present invention, are bonded by a double sided glue tape 15 to a single layer of flexible, non-slip, non-self-adhering material 11 used for the outer layer of golf glove saving pad of the present invention. The double sided glue tape 15 may be replaced by glue or by sewing to bond the materials used for inner layer and outer layer of golf glove saving pad of the present invention together. Another double sided glue tape 15′ is then attached to this combined multi-layer material at the bottom of the inner layer 14′ to form the final combined multi-layer material that is ready to be cut into different shapes to be used as golf glove saving pads of the present invention. The double sided glue tape 15′ may be replaced by a layer of releasable glue. Examples of glue useful in the present invention are 356 MultiPro and 630 PeachPro from W. W. Henry Company located in Aliquippa, Pa. and other releasable glues. The final combined multi-layer material can be cut to have an irregular pear shape 10, as shown in FIG. 2, having size of about 2¼ inches from top to bottom and about 2 inches of largest width. This irregular pear shape glove saving pad is used for the palm area of a golf glove. This final combined multi-layer material can also be cut to have an elongated oval shape 12, as shown in FIG. 3, having size of about 1⅞ inches in length and about ¾ inch in width. This elongated oval shape glove saving pad is used for the finger, such as thumb, area of a golf glove.

The second embodiment of the present invention, as illustrated in FIG. 5, for golf glove saving pads 10 and 12, as shown in FIGS. 2 and 3, comprises double outer layers 16 and 16′ and a single inner layer 11′. They are bonded together by a double sided glue tape 15. The outer double layers 16 and 16′ are made of thin, lightweight, porous, elastic material having self-adhering capability and extra non-slip feature. Examples of this type of material useful in the present invention are Coban®, Coach®, Self-Grip®, and the like. Self-Grip® is available from Dome Industries, a division of Dome Publishing Co., Inc. Warwick, R.I. Self-Grip® is a woven cotton base material containing 2% latex. The inner layer 11 is made of flexible, non-slip, non-self-adhering material. Examples of this type of material useful in the present invention are fabric, leather (natural or artificial), foam and the like. Example of the double sided glue tape 15 useful in the present invention is carpet tape from Henkel® Consumer Adhesive, Inc. located in Avon, Ohio.

In a second embodiment of the construction, as illustrated in FIG. 5, for the golf glove saving pads 10 and 12 as illustrated in FIGS. 2 and 3, a single layer of flexible, non-slip, non-self-adhering material 11′, used for the inner layer of golf glove saving pad of the present invention, are bonded by a double sided glue tape 15 to double layers of thin, lightweight, porous, elastic, material having self-adhering capability and extra non-slip feature 16 and 16′ used for the outer layer of golf glove saving pad of the present invention. The double sided glue tape 15 may be replaced by glue or by sewing to bond the inner layer and outer layer of golf glove saving pad of the present invention together. Another double sided glue tape 15′ is then attached to this combined multi-layer material at the bottom of the inner layer 11′ to form the final combined multi-layer material that is ready to be cut into different shapes to be used as golf glove saving pads of the present invention. The double sided glue tape 15′ may be replaced by a layer of releasable glue. The final combined multi-layer material can be cut to have an irregular pear shape 10, as shown in FIG. 2, having size of about 2¼ inches from top to bottom and about 2 inches of largest width. This irregular pear shape glove saving pad is used for the palm area of a golf glove. This final combined multi-layer material can also be cut to have an elongated oval shape 12, as shown in FIG. 3, having size of about 1⅞ inches in length and about ¾ inch in width. This elongated oval shape glove saving pad is used for the finger, such as thumb, area of a golf glove.

The third embodiment of the present invention, as illustrated in FIG. 6, for golf glove saving pads 10 and 12, as shown in FIGS. 2 and 3, comprises a single outer layer 17 and double inner layers 18 and 18′. The double inner layers 18 and 18′ are made of thin, lightweight, porous, elastic material having self-adhering capability. Examples of this type of material useful in the present invention are Coban® and Coach®. The single outer layer 17 is made of thin, lightweight, porous elastic material having self-adhering capability with extra no-slip feature. Example of this type of material useful in the present invention is Self-Grip®, and the like. Example of the double sided glue tape 15 useful in the present invention is carpet tape from Henkel® Consumer Adhesive, Inc. located in Avon, Ohio.

In a third embodiment of the construction, as illustrated in FIG. 6, for the golf glove saving pads 10 and 12 as illustrated in FIGS. 2 and 3, double layers of thin, lightweight, porous, elastic, self-adhering material 18 and 18′ used for the inner layer of golf glove saving pad of the present invention, are bonded to a single layer of thin, lightweight, porous, elastic, self-adhering material with extra no-slip feature 17 used for the outer layer of golf glove saving pad of the present invention. The double sided glue tape, glue or sewing may also be used to bond the inner layer and outer layer of golf glove saving pad of the present invention together but it is not necessary. This combined multi-layer material is attached to a double sided glue tape 15′ at the bottom of the inner layer 18′ of the golf glove saving pad of the present invention. The double sided glue tape 15′ may be replaced by a layer of releasable glue. The final combined multi-layer material can be cut to have an irregular pear shape 10, as shown in FIG. 2, having size of about 2¼ inches from top to bottom and about 2 inches of largest width. This irregular pear shape glove saving pad is used for the palm area of a golf glove. This final combined multi-layer material can also be cut to have an elongated oval shape 12, as shown in FIG. 3, having size of about 1⅞ inches in length and about ¾ inch in width. This elongated oval shape glove saving pad is used for the finger, such as thumb, area of a golf glove.

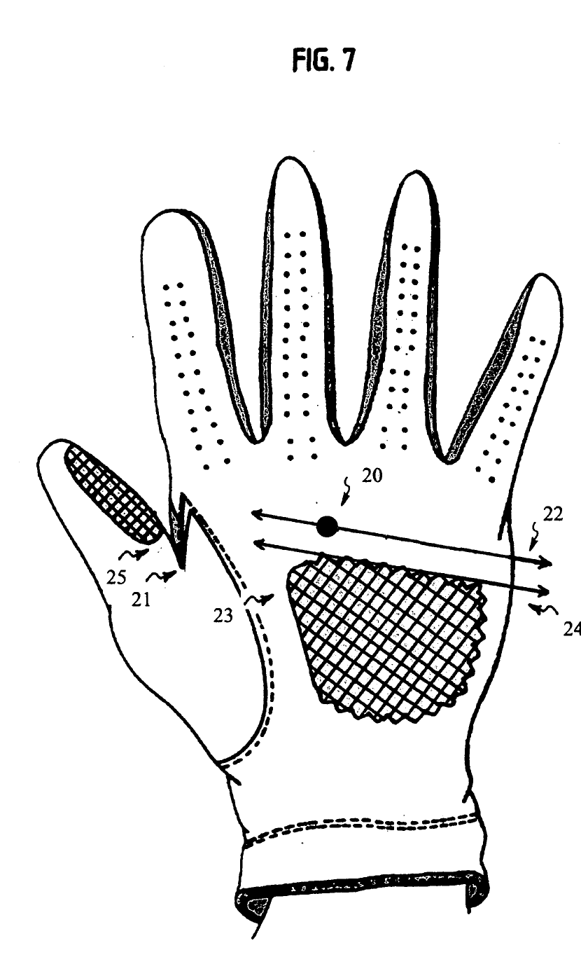

The fourth embodiment of the present invention, as illustrated in FIG. 7, comprises a golf glove that has a saving pad with an irregular pear shape at the palm area and a saving pad with an elongated oval shape at the thumb area.

In the construction of this embodiment of the present invention, use the commercially available leather golf gloves and determine the line 22 of each golf glove and point 20, where the line 22 is the line of valley across the palm area of a golf glove and point 20 is the center of the palm when a golf glove is at holding poison of a golf club. Attach an irregular pear shape glove saving pad for the palm with the bottom double sided glue tape (or bottom layer of releasable glue if it is used to replace the bottom double sided glue tape) facing down to a golf glove and with the upper edge of the saving pad following the line 24 as shown in FIG. 7, where the line 24 is about ¼ inch below and parallel to the line 22. Meanwhile, the top of the irregular pear shape glove saving pad for the palm 23 is below and close to the center of the palm 20 as shown in FIG. 7. Attach and center an elongated oval shape glove saving pad used for the finger to the inner thumb surface of a golf glove with the bottom edge 25 of the saving pad about ⅜ inch above point 21 where point 21 is the joint between the thumb and index finger of a golf glove as shown in FIG. 7.

Although, it has been shown and described with details using exemplary embodiments of the present invention, it will be understood that various changes in form, size, the number of layers of material for the outer layer or inner layer of golf glove saving pad, the combination of material for the outer layer and inner layer of golf glove saving pad and the pattern used to all sides of the present invention may be made without departing from the spirit and scope of the claimed invention. It will also be understood that the changes of the locations of saving pads on a golf glove may be made without departing from the spirit and scope of the claimed invention.

1. A removable and replaceable golf glove saving pad to be used and attached to a golf glove comprising:
an inner layer;
an outer layer overlying, and sealingly bonded to, the inner layer;
a double sided glue tape sealingly bonded to the bottom of the inner layer or a layer of releasable glue applied to the bottom of the inner layer.

2. The golf glove saving pad of claim 1 wherein the inner layer and the outer layer have same type of material.

3. The golf glove saving pad of claim 1 wherein the inner layer and the outer layer have different types of material.

4. The golf glove saving pad of claim 1 wherein there is at least one layer.

5. The golf glove saving pad of claim 1 wherein the inner layer and outer layer sealingly bonded by a double sided glue tape, glue, or by sewing.

6. The golf glove saving pad of claim 1 wherein the layer comprises elastic self-adhering material.

7. The golf glove saving pad of claim 6 wherein the layer comprises a non-woven polymer fiber base material.

8. The golf glove saving pad of claim 6 wherein the layer comprises a natural rubber latex base material.

9. The golf glove saving pad of claim 6 wherein the layer comprises a cotton base material.

10. The golf glove saving pad of claim 1 wherein the layer comprises a flexible, non-self-adhering material.

11. The golf glove saving pad of claim 10 wherein the layer composed of material with non-slip surface.

12. The golf glove saving pad of claim 11 wherein the layer comprises a leather base material, natural or artificial.

13. The golf glove saving pad of claim 11 wherein the layer comprises a foam base material.

14. The golf glove saving pad of claim 11 wherein the layer comprises a fabric base material.

15. A golf glove that can be saved to extend the normal usage life comprising:
a commercially available golf glove and golf glove saving pads.

16. The golf glove of claim 15 wherein the golf glove saving pads are removable.

17. The golf glove of claim 15 wherein the golf glove saving pads are replaceable.

18. The golf glove of claim 15 wherein the golf glove has saving pad at the palm area.

19. The golf glove of claim 15 wherein the golf glove has saving pad at the finger area.

20. The golf glove of claim 18 wherein the golf glove saving pad has an irregular pear shape.

21. The golf glove of claim 19 wherein the golf glove saving pad has an elongated oval shape.
